(19) United States
(12) Patent Application Publication
(10) Pub. No.: US 2004/0250220 A1
(43) Pub. Date: Dec. 9, 2004

(54) System, apparatus, and method for navigation in a hypertext document

(76) Inventor: Mika Kalenius, Espoo (FI)

Correspondence Address: CRAWFORD MAUNU PLLC, 1270 Northland Drive, Suite 390, St. Paul, MN, 55120, US

(21) Appl. No.: 10/457,803

(22) Filed: Jun. 9, 2003

(51) Int. Cl. G09G 5/00; G09G 5/08; H04B 1/38

(52) U.S. Cl. 715/864; 345/158; 715/841; 715/851; 715/863; 455/566

(57) ABSTRACT

A system, apparatus, and method for navigation between sub-frames of a hypertext document and hyperlinks contained within the sub-frames are provided for mobile devices without pointing capability. A first mode of screen navigation renders the hypertext document into sub-frames, where each sub-frame is accessed using navigation commands. A second mode of screen navigation uses normal rendering mode, whereby a scrolling window is used to display the active portion of the hypertext document. Whether the first or the second mode of screen navigation is used, a hyperlink navigation mode may be initiated once the frame of interest is located. Similar navigational inputs are then used to navigate between the hyperlinks contained within the frame of interest.

### FIELD OF THE INVENTION

This invention relates in general to hypertext document navigation, and more particularly, to hypertext document navigation in mobile devices having limited viewing area and limited resources with which to provide navigation command input.

### BACKGROUND OF THE INVENTION

The mobile industry has experienced a period of exceptional growth during the past several years, where mobile voice and simple Short Message Service (SMS) text messaging have provided the primary drivers for this growth. The next wave of growth is expected to come from new mobile services where content, not just voice, will be mobilized. To insure a successful launch of these new mobile services, service enablers are used to create the mobile services according to at least the following criteria: enablement of new and better services for consumers; provision of facilities to developers to speed up the development of the mobile services; and insuring interoperability through the use of open global standards.

The use of open global standards, such as those endorsed by the Open Mobile Alliance (OMA), minimizes fragmentation of the service enablers and insures seamless interoperability between different vendors. Some of the key service enablers used for the successful take-up of the mobile services include: Multimedia Messaging Service (MMS); Mobile Digital Rights Management (MDRM); and mobile browsing, to name only a few.

The essence of mobile browsing lies in its close alignment with widely accepted internet standards. The Wireless Application Protocol (WAP) Forum and the World Wide Web Consortium (W3C) have successfully defined mobile internet standards over the past several years. Just recently, the WAP Forum has adopted the Extensible HyperText Markup Language (XHTML) Basic standard from the W3C as the basis for the latest revision of WAP. The transition to XHTML Basic will strengthen the position of the mobile browser in the mainstream Internet and allow for a far greater range of presentation and formatting than previously possible.

The essential elements of browsing content includes: a page description language; a content formatting language; and a scripting language. These elements enable consumers to enjoy a wider array of services, more intuitive user interfaces, and a generally more useful experience. At the same time, carriers will be able to exercise more control over the look and feel of services they provide through their mobile portals. According to the W3C specification, XHTML Basic defines a document type that is rich enough to be used for content authoring and precise document layout, yet can be shared across different classes of devices, such as desktop computers, Personal Digital Assistants (PDA), TV, mobile devices, etc.

One of the many challenges presented by mobile browsing, however, is the display size limitation of the mobile device. Frame presentation to certain mobile devices, as it is known in the art, is not practical because of the horizontal and vertical size limitations imposed by the mobile device display. Mobile device access to an HTML frame that has been rendered for a desktop browser, for example, allows only a portion of the frame to be viewed at any given time by the mobile device. Accordingly, navigation throughout the frame entails a series of vertical and horizontal scrolling movements that requires a high degree of laborious interaction by the user.

Other document/presentation formats designed for larger displays pose problems for the mobile display as well. For example, document formats such as Portable Document Format (PDF), Macromedia Flash, Synchronized Multimedia Integration Language (SMIL), Scalable Vector Graphics (SVG), etc. may not allow rendering of the document to fit within the constraints of the mobile device display. Rendering in some cases would, for example, break up the original layout and structure of the document. User interaction, therefore, is required to navigate within the document.

Mobile devices that are designed for one-hand operation, however, do not provide for navigational input devices such as stylus/touch screen, mouse pointer, virtual cursor, etc. Rather, navigational keys that allow directional commands, e.g., up, down, left, and right, are all that may be offered on the mobile terminal. Prior art methods to navigate within these larger documents using the one-handed mobile terminals, therefore, require the user to “tab” over to the next hyperlink/hotspot contained within the documents using their navigational keys. For larger documents, however, “tabbing” to each and every hyperlink/hotspot within the document is laborious and time consuming.

Accordingly, there is a need in the communications industry for a system, apparatus, and method that facilitates navigation within documents displayed using mobile terminals. In particular, a convenient method is required to simultaneously navigate within a page and select hyperlinks without the need for pointing devices. Additionally, a need exists that allows navigation of all hyperlinks within an electronic document from the first to the last, while simultaneously allowing page scrolling without the need for a pointing device.

### SUMMARY OF THE INVENTION

To overcome limitations in the prior art, and to overcome other limitations that will become apparent upon reading and understanding the present specification, the present invention discloses a system, apparatus, and method for navigating electronic documents using a reduced size, mobile device display without the use of pointing devices.

In accordance with one embodiment of the invention, a network browsing system is provided. The network browsing system comprises a network having Web pages addressable by a Uniform Resource Locator (URL), and a browsing entity coupled to access the Web pages and coupled to receive markup definitions associated with the Web pages. The browsing entity generates a content window from a portion of the Web page. Navigation to the content window and within the content window is facilitated without the use of a pointing device.

In accordance with another embodiment of the invention, a mobile terminal wirelessly coupled to a network having Web pages accessible by a Uniform Resource Locator (URL) is provided. The mobile terminal comprises a memory capable of storing at least one of a mobile browser and a rendering module, a transceiver configured by the mobile browser to facilitate markup language exchange with a plurality of Web pages, and a processor coupled to the memory and configured to render a browser window corresponding to a portion of an exchanged Web page and facilitating navigation within the browser window without the use of a pointing device.

In accordance with another embodiment of the invention, a computer-readable medium having instructions stored thereon which are executable by a mobile terminal for rendering browser windows by performing steps comprising, receiving documents containing hyperlinks, defining a browser window to display selected portions of the document, and freezing the browser window to allow navigation within the browser window. The selected portions of the document and navigation within the selected portions are facilitated without the use of a pointing device.

In accordance with another embodiment of the invention, a method for rendering browser windows on a mobile terminal is provided. The method comprises receiving markup definitions, defining portions of the markup definitions to be displayed by a browser window, and navigating between the defined portions without the use of a pointing device.

In accordance with another embodiment of the invention, a method for navigating within a browser window generated by a mobile browser is provided. The method comprises locating keywords contained within a document displayed by the browser window, highlighting a portion of the browser window corresponding to a selected keyword, and selecting the keywords without the use of a pointing device.

These and various other advantages and features of novelty which characterize the invention are pointed out with greater particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described specific examples of a system, apparatus, and method in accordance with the invention.

### BRIEF DESCRIPTION OF THE DRAWINGS

The invention is described in connection with the embodiments illustrated in the following diagrams.

FIG. 1 illustrates an exemplary communication system in which the principles of the present invention may be utilized;

FIG. 2 illustrates an exemplary document rendering that may be navigated in accordance with the present invention;

FIG. 3 illustrates an alternative document rendering that may be navigated in accordance with the present invention;

FIG. 4 illustrates an exemplary content window that may be displayed in accordance with the present invention;

FIG. 5 illustrates an exemplary frame scrolling flow diagram in accordance with the present invention;

FIG. 6 illustrates an exemplary navigation flow diagram in accordance with the present invention; and

FIG. 7 illustrates a representative mobile computing arrangement suitable for navigating Web pages in accordance with the present invention.

### DETAILED DESCRIPTION OF THE INVENTION

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention is directed to a system, apparatus, and method that allows users of mobile terminals to view electronic documents with a display that is smaller than the document to be viewed. A viewing rectangle defined by the mobile terminal allows different portions of the electronic document to be viewed by the mobile terminal user. Once the desired portion of the document is within the viewing rectangle, the user may freeze the viewing rectangle to allow hyperlink navigation within the viewing rectangle. Portions of the electronic document and hyperlinks within those portions are navigable without the need to use pointing devices.

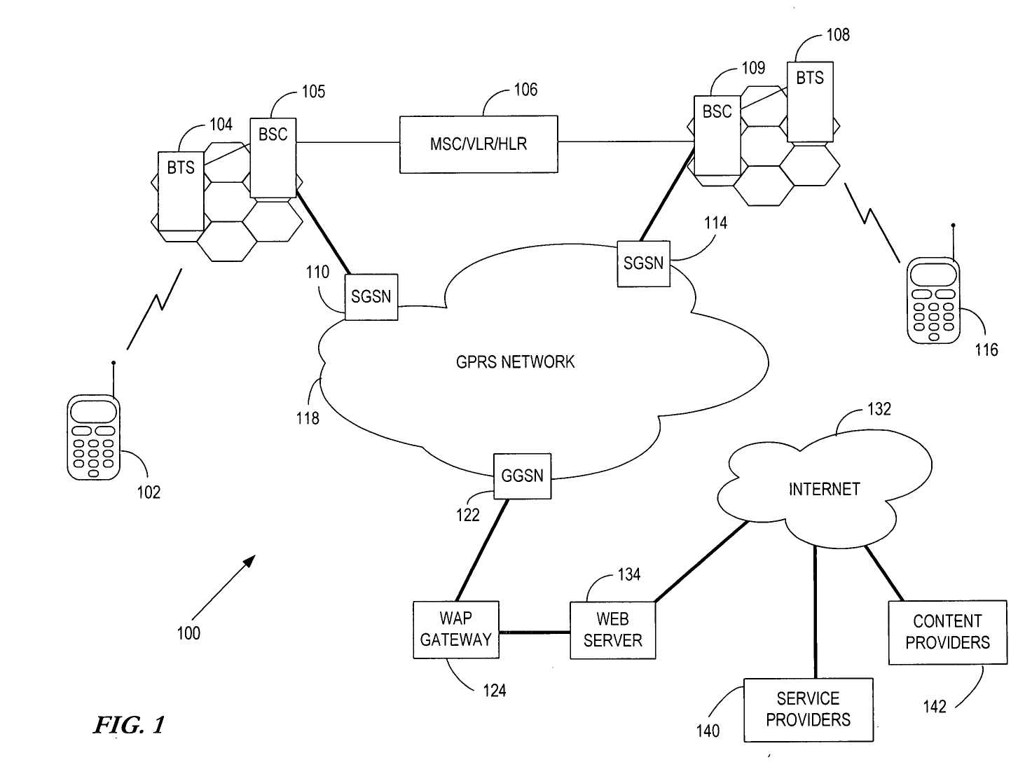

FIG. 1 illustrates exemplary communication system 100 in which the principles of the present invention may be utilized. Communication system 100 utilizes General Packet Radio Service (GPRS) network 118 as the communications backbone. GPRS is a packet-switched service for the Global System for Mobile Communications (GSM) that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. While the exemplary embodiments of FIG. 1 are generally described in connection with GPRS/GSM, it should be recognized that the specific references to GSM and GPRS are provided to facilitate an understanding of the invention. As will be readily apparent to those skilled in the art from the description provided herein, the invention is equally applicable to other technologies, including other circuit-switched and packet-switched technologies, 3G technologies, and beyond.

Referring to FIG. 1, mobile terminals 102 and 116 communicate with Base Transceiver Station (BTS) 104 and 108, respectively, via an air interface. BTS 104 and 108 are components of the wireless network access infrastructure that terminates the air interface over which subscriber traffic is communicated to and from mobile terminals 102 and 116. Base Station Controller (BSC) 105 and 109 are switching modules that provide, among other things, handoff functions, and power level control in each BTS 104 and 108, respectively. BSC 105 and 109 controls the interface between a Mobile Switching Center (MSC) 106 and BTS 104 and 108, and thus controls one or more BTSs in the call set-up functions, signaling, and use of radio channels. BSC 105 and 109 also controls the respective interfaces between Serving GPRS Support Node (SGSN) 110 and BTS 104 and SGSN 114 and BTS 108.

SGSN 110 serves a GPRS mobile terminal by sending or receiving packets via a Base Station Subsystem (BSS), and more particularly via BSC 105 and 109 in the context of GSM systems. SGSN 110 and 114 are responsible for the delivery of data packets to and from mobile terminals 102 and 116, respectively, within the service area, and they perform packet routing and transfer, mobility management, logical link management, authentication, charging functions, etc. In the exemplary GPRS embodiment shown in FIG. 1, the location register of SGSN 110 stores location information such as the current cell and Visiting Location Register (VLR) associated with mobile terminal 102, as well as user profiles such as the International Mobile Subscriber Identity Number (IMSI) of all GPRS users registered with SGSN 110. SGSN 114 performs similar functions relating to mobile terminal 116. While GSM forms the underlying technology, SGSN 110 and 114 described above are network elements introduced through GPRS technology. Another network element introduced in the GPRS context is the Gateway GPRS Support Node (GGSN) 122, which acts as a gateway between the GPRS network 118 and WAP gateway 124. Access to Internet 132 and corresponding service and content providers, 140 and 142 respectively, is provided to mobile terminals 102 and 116 via Web server 134.

WAP enhances the functionality of mobile terminals through real-time interactive services. The protocol has been specifically designed for small screens and low bandwidths, and it offers a wide variety of wireless services over the Internet for mobile devices. It was also designed to allow content to be delivered over any bearer service, even when delivery of the services is enabled over GPRS, 3G, or any other type of network. WAP over GPRS opens up new possibilities for application development and there are also some optimizations in GPRS that can be performed by service developers.

Application developers can use the principles of WAP to develop new services or adapt existing Internet applications for use with mobile devices. Applications are written in Wireless Markup Language (WML) and WMLScript (WMLS) and are stored on either Web server 134 or directly on WAP gateway 124. The content stored on Web server 134 is accessible from mobile devices 102 and 116 via GPRS network 118, GGSN 122, and WAP gateway 124. It is recommended to use a HyperText Transfer Protocol (HTTP) proxy (not shown) to cache WML content whenever the content is accessed via Internet 132. The proxy should either be co-located with WAP gateway 124 or proximately located next to WAP gateway 124 in order to minimize the delay in data transfer between the two components.

Mobile devices 102 and 116 access WAP gateway 124 using a GSM data call, where they supply a user-agent field within a Wireless Session Protocol (WSP) header when fetching content from Web server 134. WAP gateway 124 then encapsulates the WSP header within an HTTP header prior to sending to Web server 134. The WSP header is utilized by Web server 134 to, for example, determine the particular browser that is being utilized by mobile devices 102 and 116, so that suitable content may be delivered to mobile devices 102 and 116 by Web server 134.

Web pages, i.e., XHTML/HTML pages, found within Internet 132 are mainly designed for larger displays found on desktop computers, fixed Internet terminals, TV monitors, etc. The horizontal and vertical dimensions of these Web pages are usually much larger than Web pages that are specifically designed to fit within the diminutive constraints of a mobile terminal's display. Most of the Web pages can be successfully rendered to fit within the screen size of the mobile terminal by reducing, for example, the resolution or quality of the image or document to be displayed. However, approximately 20%-30% of the Web pages located within Internet 132 are designed in such a way that it is technically impossible to render the Web pages to the small/narrow mobile terminal display without making the Web page unusable. Similar problems exist with other forms of document/presentation formats such as PDF, Macromedia Flash, SMIL, and SVG to name only a few.

Internet browsers that are designed for small/narrow screens like those found on most mobile terminals usually have, for example, two modes in which content may be displayed. In the first mode, content is rendered to “fit” the width parameters of the mobile terminal's display screen in a way that there is no need for horizontal scrolling. In this mode, the user of the mobile terminal may use the advantages of the present invention to alternate between viewing rectangles, i.e., that portion of the document currently viewable on the mobile terminal's display. In particular, the entire Web document may eventually be viewed, page by page, by selecting, for example, only the “up” or the “down” navigation keys on the mobile terminal.

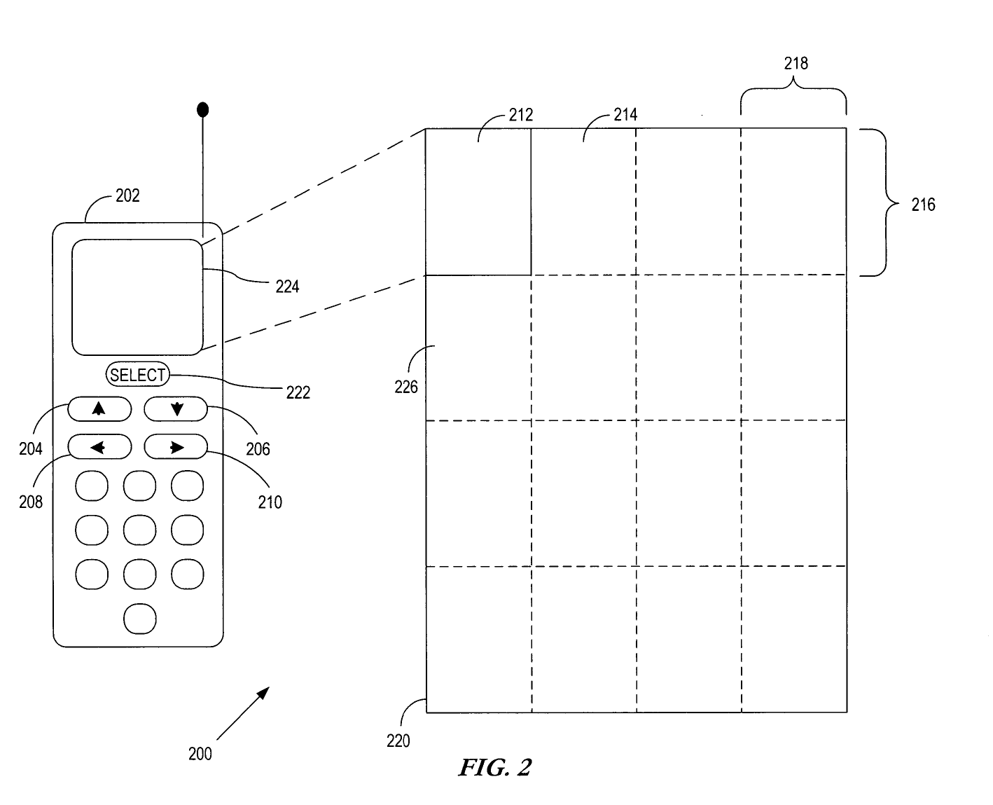

FIG. 2 illustrates exemplary XHTML document rendering 200 that may be navigated in accordance with the present invention, where a first mode of content rendering, or small/narrow screen rendering mode, is presented. In small/narrow screen rendering mode, the markup content is formatted to display 224 in such a way that horizontal scrolling is unnecessary. As can be seen, XHTML document 220 is too large to be entirely rendered onto the display of mobile terminal 202, while maintaining readability and coherency. Thus, the content of XHTML document 220 must be divided into sub-components 214 and then individually rendered onto display 224. It should be noted that although document 220 is described as being defined by XHTML, document 220 may be of any format such as HTML, PDF, Macromedia Flash, SMIL, SVG, etc. that may be accessed by mobile terminal 202. Any XHTML discussion is, therefore, presented for purposes of illustration and is not intended to limit the scope of the present invention in any way.

The small/narrow screen rendering mode divides XHTML document 220 into, for example, 16 sub-components, or frames, 214 of equal, or near equal, dimension. Width dimension 218 and height dimension 216 are sufficiently arranged to “fit” within a viewing rectangle of display 224, such that the content of frame 214 may be adequately displayed to be coherent and easily understood.

In one embodiment, the rendering process may be performed within mobile terminal 202 for each document received by mobile terminal 202. In such a case, the entire XHTML page definitions for page 220 may be downloaded to mobile terminal 202 for subsequent rendering. In another embodiment, content may alternately be rendered by an external rendering service, which is convenient, for example, when content is to be mass distributed to terminals of similar display characteristics. For example, several users may possess mobile terminals having display characteristics similar to that of display 224 and each may subscribe to a weather update service. In such an instance, content may be mass distributed from a weather update service, e.g., service providers 140 of FIG. 1, to each receiving mobile terminal as a series of frame definitions, where each frame definition conforms to pre-negotiated geometrical constraints that are compatible with display 224. Each frame definition would then be separately stored into local memory (not shown) contained within mobile terminal 202 and displayed in accordance with navigation techniques as described below.

Navigation between frames 214 may be facilitated in several different ways. In a first embodiment, mobile terminal 202 is arranged with four navigation keys, e.g., 204-210. If frame 212 is the current frame that is rendered to the viewing rectangle of display 224, for example, then a press of the “right” key 210 causes the small/narrow screen rendering mode to display the contents of frame 214. Similarly, a press of “down” key 206 results in the rendering of frame 226 onto the viewing rectangle of display 224. Once the user has located a frame of interest, a key press of “select” 222 results in freezing the frame in preparation for hyperlink navigation mode discussed below.

In another embodiment according to the present invention, a user of mobile terminal 202 may navigate with verbal commands issued to mobile terminal 202 in relation to the current frame. For example, if frame 212 is the current frame that is rendered to the viewing rectangle of display 224, then a verbal command of, for example, “navigate right” causes the small/narrow screen rendering mode to display the contents of frame 214. Similarly, a verbal command of, for example, “navigate down” results in the rendering of frame 226 onto the viewing rectangle of display 224. Once the user has located a frame of interest, a verbal command of, for example, “select” results in freezing the frame in preparation for hyperlink navigation mode discussed below.

In another embodiment according to the present invention, a user of mobile terminal 202 may navigate with acceleration/tilt commands issued to mobile terminal 202 in relation to the current frame. For example, if frame 212 is the current frame that is rendered to the viewing rectangle of display 224, then tilting mobile terminal 202 to the right causes the small/narrow screen rendering mode to display the contents of frame 214. Similarly, tilting mobile terminal 202 downward results in the rendering of frame 226 onto the viewing rectangle of display 224.

In another embodiment according to the present invention, a user of mobile terminal 202 may only have two navigation keys, e.g., up/down keys 204/206, to choose from. In such an instance, successive key strokes of the “up” key causes frames to be displayed in ascending order and successive key strokes of the “down key” causes frames to be displayed in descending order. For example, if frame 212 is the current frame that is rendered to the viewing rectangle of display 224, then a single press of “down” key 206 causes the small/narrow screen rendering mode to display the contents of frame 214. Similarly, three more successive key strokes of the “down” key results in the rendering of frame 226 onto the viewing rectangle of display 224. In order to return to frame 212 from frame 226, four successive key strokes of the “up” key are required.

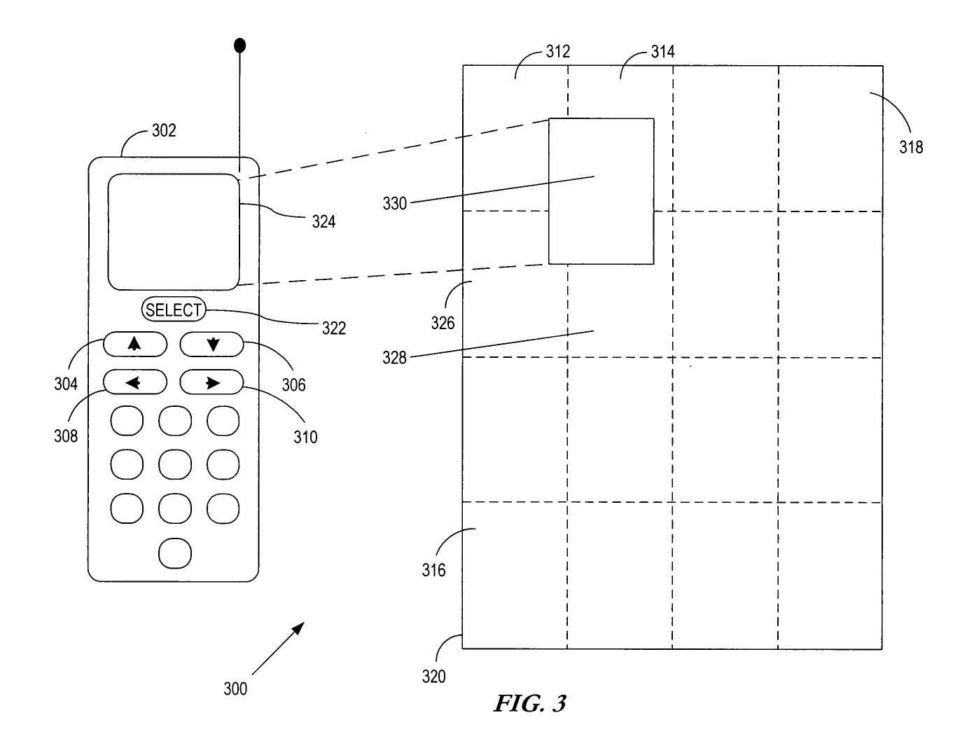

FIG. 3 illustrates alternative XHTML document rendering 300 that may also be navigated in accordance with the present invention, where a second mode of content rendering, or normal rendering mode, is presented. In normal rendering mode, the markup content is formatted to display 324 in such a way that horizontal and vertical scrolling are both necessary. As can be seen, XHTML document 320 is too large to be entirely rendered onto the display of mobile terminal 302, while maintaining readability and coherency. Thus, content on XHTML page 320 must be rendered in accordance with scrolling frame 330.

Initially, scrolling frame 330 originates in position 312 of XHTML page 320, where the contents of frame 312 are rendered onto display 324 in accordance with the viewing rectangle defined by display 324. Navigation to other portions of XHTML page 320 do not occur on frame boundaries, as defined for example by frames 312, 314, 326, and 328, but rather occurs by sliding the scrolling frame 330 across XHTML page 320 using a series of key press, verbal, an/or acceleration/tilt commands.

In one embodiment, mobile terminal 302 is arranged with four navigation keys, e.g., 304-310. If frame 312 is the current frame that is rendered to the viewing rectangle of display 324, then a press of the “right” key 310 causes scrolling frame 330 to move one increment to the right. Similarly, a press of “down” key 306 results in moving the scrolling frame by one increment downward. The definition of a single increment may be predetermined by the user through the use of a configuration screen to have any number of different meanings. In one embodiment, the user may define an increment to be some fraction of one dimension of display 324. If a left/right command key is pressed for example, scrolling window 330 may be configured to change by 10% of the total horizontal distance defined by display 324. Alternately, if an up/down command key is pressed, scrolling window 330 may be configured to change by 10% of the total vertical distance defined by display 324.

The current position of scrolling window 330 is illustrated to overlap frames 312, 314, 326, and 328 as shown in FIG. 3. Accordingly, the vertical rectangle of display 324 displays the lower right corner of frame 312, the majority of the lower portion of frame 314, the upper right corner of frame 326, and the majority of an upper portion of frame 328. Once the user has defined an acceptable position of scrolling frame 330, a key press of “select” 322 results in freezing scrolling frame 330 in its current position in preparation for hyperlink navigation mode discussed below.

In another embodiment according to the present invention, a user of mobile terminal 302 may navigate with verbal commands issued to mobile terminal 302 in relation to the current frame. For example, if scrolling frame 330 is situated completely over position 312 such that frame 312 is rendered to the viewing rectangle of display 324, then a verbal command of, for example, “navigate right” causes the normal rendering mode to move scrolling window 330 one increment to the right and to display the contents associated with the new position defined by scrolling window 330. Similarly, a verbal command of, for example, “navigate down” results in the rendering of the contents of page 320 overlapped by scrolling frame 330 onto the viewing rectangle of display 324. Once the user has defined an acceptable position of scrolling frame 330, a verbal command of, for example, “select” results in freezing scrolling frame 330 in its current position in preparation for hyperlink navigation mode discussed below.

In another embodiment according to the present invention, a user of mobile terminal 302 may navigate with acceleration/tilt commands issued to mobile terminal 302 in relation to the current frame. For example, if scrolling frame 330 is currently situated over position 312, then tilting mobile terminal 302 to the right causes the normal rendering mode to move scrolling window 330 one increment to the right, thus overlapping a portion of position 314. Similarly, tilting mobile terminal 302 downward results in moving scrolling window down by one increment, thus overlapping a portion of position 326.

In another embodiment according to the present invention, a user of mobile terminal 302 may only have two navigation keys, e.g., up/down keys 304/306 or left/right keys 308/310, to choose from. In such an instance, successive key strokes of “up” key 304, for example, causes scrolling window 330 to slide upward and successive key strokes of “down” key 306, for example, causes scrolling window 330 to slide downward. Similarly, successive key strokes of “left” key 308, for example, causes scrolling window 330 to slide leftward and successive key strokes of “right” key 310, for example, causes scrolling window 330 to slide rightward. Once scrolling window 330 has reached either the left, right, top, or bottom boundary of XHTML page 320, then scrolling window 330 must reset itself to the opposite boundary to prepare for the next scrolling pass.

For example, if frame 312 is the origin of scrolling window 330 during navigation in normal rendering mode, then enough downward movements of scrolling window 330 causes it to completely overlap frame 316. One more successive downward movement causes scrolling window to automatically reposition itself to the position defined by frame 314 and the user may continue his or her downward sliding of scrolling window 330. Alternatively, if frame 312 is the origin of scrolling window 330 during navigation in normal rendering mode, then enough rightward movements of scrolling window 330 causes it to completely overlap frame 318. One more successive rightward movement causes scrolling window to automatically reposition itself to position defined by frame 326 and the user may continue his or her rightward sliding of scrolling window 330.

Once the viewing rectangle of the user's mobile terminal displays interesting content, whether it was navigated to by small/narrow screen rendering mode or by normal rendering mode, the user may freeze the frame currently displayed and may enter hyperlink navigation mode. Hyperlink navigation mode may be entered, for example, by pressing the “select” key or by issuing an appropriate verbal command such as “select”, once the user has located a frame of interest having one or more hyperlinks or “hot spots” where user interaction is required.

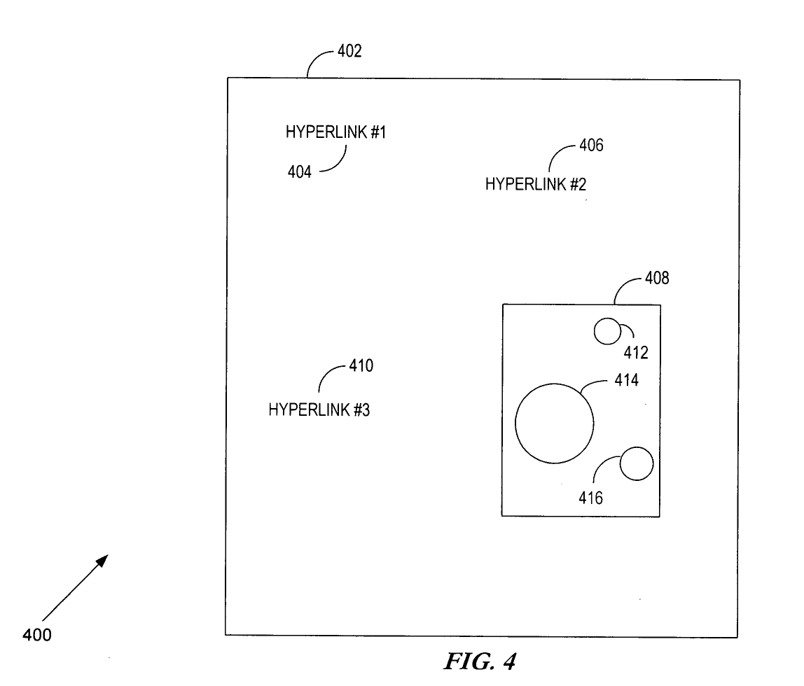

FIG. 4 illustrates exemplary content 400 that may be displayed by viewing rectangle 402 once the user has entered hyperlink navigation mode. Exemplary content 400 contains hyperlinks 404, 406, and 410, as well as image map 408 having hot spot regions 412-416 defined within. Ordinarily, users of mobile terminals having pointing capability would easily be able to select any one of the hyperlink/hot spot regions defined within viewing rectangle 402. Users of mobile terminals without such pointing capability, however, require the advantages of the present invention to select the hyperlink/hot spot regions of interest.

In one embodiment according to the present invention, hyperlink 404 may be highlighted once hyperlink navigation mode has been entered, in order to signify that hyperlink 404 is the currently active hyperlink associated with viewing rectangle 402. Upon either a verbal “select” command or a key press “select” command, for example, the Uniform Resource Locater (URL) associated with hyperlink 404 would be contacted by the browser contained within the user's mobile terminal. New content defined by the URL would then be rendered to the user's terminal in either small/narrow screen rendering mode or normal rendering mode as discussed above.

Alternatively, the user may wish to select one of the remaining hyperlinks/hot spots contained within viewing rectangle 402 as the currently active hyperlink/hot spot. In a first embodiment, assuming that the mobile terminal of FIG. 2 is being utilized, mobile terminal 202 is arranged with four navigation keys, e.g., 204-210. If hyperlink 404 is the current active link, then a press of the “right” key 210 causes the hyperlink/hot spot navigation mode to highlight hyperlink 406 as the currently active link. Similarly, a press of “down” key 206 results in the highlighting of hyperlink 410 as the currently active link. Successive “right” or “down” key presses will cycle through each of hot spots 412, 414, and 416, causing each to be visually highlighted, since they represent XHTML images and associated hyperlinks. Once the user has located a hyperlink/hot spot of interest, a key press of “select” 222, or alternatively a verbal command of, for example “select”, causes the browser of mobile terminal 202 to contact the URL associated with the hyperlink/hot spot. The subsequent display of the URL's contents to display 224 then occurs in accordance with either small/narrow screen rendering mode or normal rendering mode as discussed above.

In another embodiment according to the present invention, a user of mobile terminal 202 may navigate through the hyperlinks/hot spots in relation to current frame 402 with verbal commands issued to mobile terminal 202. For example, if hyperlink 404 is the current active link, then a verbal command of, for example, “navigate right” causes the hyperlink/hot spot navigation mode to highlight hyperlink 406 as the currently active link. Similarly, a verbal command of, for example, “navigate down” results in the highlighting of hyperlink 410 as the currently active link. Successive “right” or “down” verbal commands will cycle through each of hot spots 412, 414, and 416, causing each to be visually highlighted, since they represent XHTML images having associated hyperlinks. Once the user has located a hyperlink/hot spot of interest, a key press of “select” 222, or alternatively a verbal command of for example “select”, causes the browser of mobile terminal 202 to contact the URL associated with the hyperlink/hot spot and the subsequent display of its contents to display 224 in accordance with either small/narrow screen rendering mode or normal rendering mode as discussed above.

In another embodiment according to the present invention, a user of mobile terminal 202 may navigate with acceleration/tilt commands issued to mobile terminal 202 in relation to current frame 402. For example, if hyperlink 404 is the currently active link, then tilting mobile terminal 202 to the right causes the hyperlink navigation mode to highlight hyperlink 406. Similarly, tilting mobile terminal 202 downward results in the highlighting of hyperlink 410 to indicate its currently active state.

In another embodiment according to the present invention, a user of mobile terminal 202 may only have two navigation keys, e.g., up/down keys 204/206, to choose from. In such an instance, successive key strokes of the “up” key causes hyperlinks/hot spots to be highlighted in ascending order and successive key strokes of the “down” key causes hyperlinks/hot spots to be highlighted in descending order. For example, if hyperlink 404 is the currently active link, then a single press of “down” key 206 causes hyperlink 406 to be highlighted. Similarly, three more successive key strokes of the “down” key results in the highlighting of hot spot 414 as the currently active image.

Any number of methods exists according to the present invention to indicate that a particular hyperlink/hot spot is currently active. In one embodiment, any image or text associated with the hyperlink/hot spot may be highlighted, or illustrated in bold type on the mobile terminal's display. In another embodiment, an image or text associated with the hyperlink/hot spot may be alternated between its visible and non-visible state to indicate that it is currently active. In another embodiment, a combination of visual and tactile feedback mechanisms may be used to indicate the currently active hyperlinks/hot spot.

An exemplary code sequence that generates the hyperlinks and hot spots displayed by viewing rectangle 402 is illustrated in code sequence (1). It can be seen that each hyperlink is established with an anchor tag, i.e., “a” tag, that is used to create an anchor from viewing rectangle 402, and an “href” attribute used to address the document to link to, e.g., HYPERLINK #1 links to “http://www.hyperlink1.com/”. Similarly, image map 408 is created having, for example, images of the sun 414, mercury 412, and venus 416, where each planet/star image is itself a hyperlink, e.g., href=“../images/planets/sun.htm” creates a hyperlink to the file that defines the image of the sun.

The mobile browser executing within mobile terminal 202, for example, need only locate the “href” attributes within code sequence (1) when the user is using hyperlink navigation mode. For example, if hyperlink 404 in viewing rectangle 402 is the currently active hyperlink, then the browser knows that “http://www.hyperlink1.com/” is the currently active hyperlink. A subsequent “navigate right” command would cause the browser to search code sequence (1) for the next occurrence of keyword “href”. The browser

| | |
|---|---|
| <!DOCTYPE html | (1) |

PUBLIC “-//W3C//DTD XHTML 1.0 Strict//EN”
“http://www.w3.org/TR/xhtml1/DTD/xhtml1-strict.dtd”>
<html>
<body>
<p>
<a href=“http://www.hyperlink1.com/”>
HYPERLINK #1</a>
</p>
<p>
<a href=“http://www.hyperlink2.com/”>
HYPERLINK #2</a>
</p>
<p>
<a href=“http://www.hyperlink3.com/”>
HYPERLINK #3</a>
</p>
<img src=“../images/circles.gif”
width=“125” height=“145”
usemap=“#planetmap”>
<map id=“planetmap” name=“planetmap”>
<area shape=“rect”
coords=“0,0,82,126”
alt=“Sun”
href=“../images/planets/sun.htm”>
<area shape=“circle”
coords=“90,58,3”
alt=“Mercury”
href=“../images/planets/mercur.htm”>
<area shape=“circle”
coords=“124,58,8”
alt=“Venus”
href=“../images/planets/venus.htm”>
</map>
</body>
</html>

could then determine that “http://www.hyperlink2.com/” is the next currently active hyperlink. Accordingly, any code sequence that defines contents of viewing rectangle 402 may likewise be parsed and identified for hyperlinks while the user is navigating in hyperlink navigation mode. It is apparent to one of ordinary skill in the art that parsing and identification of markup language may be done in any number of different ways. Accordingly, the above description is merely one embodiment used for description purposes only and is not intended to limit the scope of the invention in any way.

Once hyperlink navigation mode has been activated, the user may transition back to either the small/narrow screen rendering mode or the normal rendering mode in several different ways. In one embodiment, once the user has highlighted, for example, either hyperlink 404 or image 416, the browser is aware that these hyperlinks represent either the first or the last hyperlink that is viewable within viewing rectangle 402. If the user then generates a navigation command that causes the browser to reach, for example, the beginning or the end of code sequence (1) in search for another keyword such as “href”, then the browser automatically transitions back to frame scrolling mode defined by either of the small/narrow screen or normal rendering modes discussed above.

In another embodiment, once the user has highlighted, for example, either hyperlink 404 or image 416, the browser is aware that these hyperlinks represent either the first or the last hyperlink that is viewable within viewing rectangle 402. If the user then generates a navigation command that causes the browser to reach, for example, the beginning or the end of code sequence (1) in search for another keyword such as “href”, the browser then automatically circles back to either the beginning or end of code sequence (1). For example, if the currently active hyperlink/hot spot is hyperlink 416, then a subsequent “down” navigation command causes the browser to circle back around to hyperlink 404 to make it the currently active hyperlink. Alternatively, if the currently active hyperlink/hot spot is hyperlink 404, then a subsequent “up” navigation command causes the browser to circle back around to hyperlink 416 to make it the currently active hyperlink.

In this fashion, the user remains in a circular hyperlink navigation mode until commanded to leave circular hyperlink navigation mode. In one embodiment, the user may leave circular hyperlink navigation mode by pressing a “back” key (not shown), or alternatively, by selecting a corresponding “back” menu option selection (not shown). In another embodiment, if no “back” keys or menu options exist, the user may depress an available navigation key, e.g., up/down keys 204/206, for a longer period of time than normal. The required period of time necessary to transition from hyperlink navigation mode to frame scrolling mode is configurable and may be selected, for example, by the user via a configuration screen or at time of provisioning mobile terminal 202.

A possibility exists such that current frame 402 may represent the entire markup content of a particular URL. In such a case, no other frames exist that would necessitate using either small/narrow screen, or normal, scrolling mode. Therefore, hyperlink navigation mode is the default navigation mode used by the browser for that particular URL.

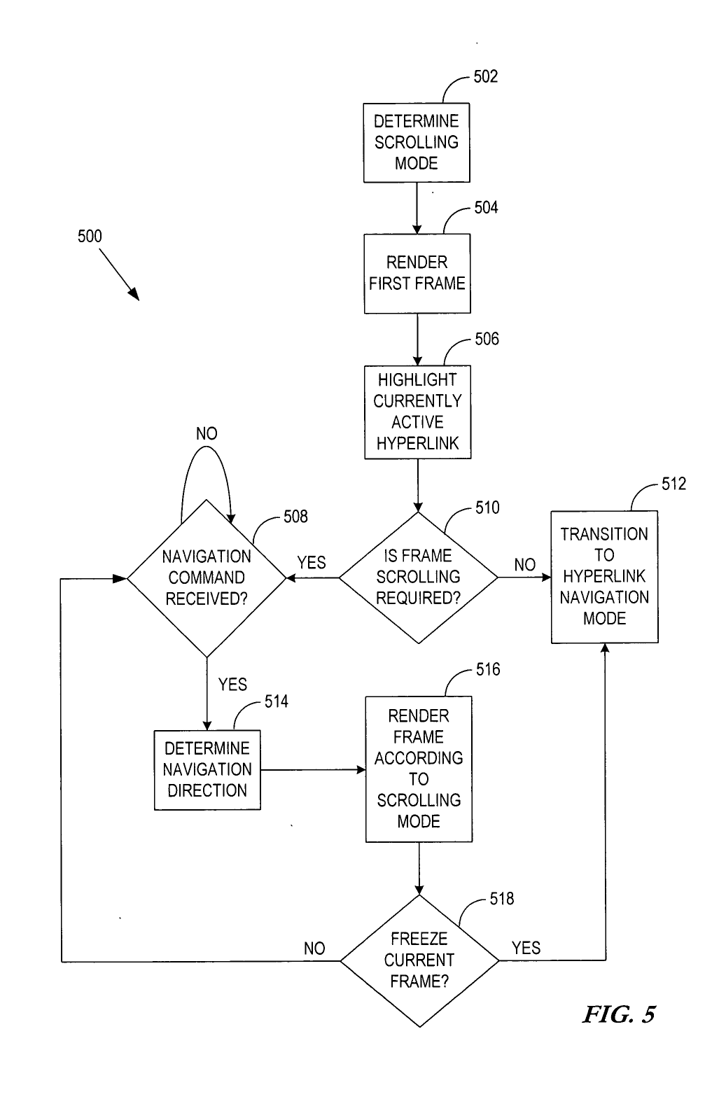

FIG. 5 illustrates exemplary flow diagram 500 of frame scrolling in accordance with the present invention. It is assumed that mobile terminal 102, having no pointing capability, is accessing content from Internet 132 addressed by URLs discovered by a browser executing within mobile terminal 102. In step 502, the predetermined frame scrolling mode is retrieved from the configuration memory for mobile terminal 102. The available frame scrolling modes available are, for example, either small/narrow screen rendering, or normal rendering mode as discussed above. Using the mobile terminal's browser, the user selects a particular URL of interest from Internet 132 via any one of verbal, key press, or acceleration/tilt commands issued to the browser.

The first frame of the URL is rendered in step 504 in accordance with markup language associated with the URL and is subsequently displayed to the user. The browser then determines the first hyperlink/hot spot (if any) located within the first frame and highlights it in step 506 to indicate that it is the currently active hyperlink/hot spot. If the browser determines in step 510 that the first frame is the only frame required to display the contents of the URL, e.g., the </body> tag of the XHTML file defining the URL is located by the browser before any more un-displayed markup content is found, then hyperlink navigation mode is entered automatically as in step 512.

If, on the other hand, more content exists that remains un-displayed, then the browser does not automatically enter hyperlink navigation mode. Rather, the browser waits for frame scrolling commands to be issued by the user as in step 508. If a navigation command is received, then the direction of the command is first determined in step 514. Next, step 516 renders the requested frame in accordance with the particular frame scrolling mode that is configured to be active at that time. For example, the user may have selected small/narrow screen rendering mode, in which case either the previous or the next frame in relation to the current frame is rendered for display. If, on the other hand, normal scrolling mode is active, then the increment size data is retrieved from configuration memory and the appropriate frame contents corresponding to the new position of the scrolling window are rendered for display onto mobile terminal 102. At this point, either the user wishes to freeze the currently rendered frame for hyperlink navigation, or the user wishes to continue frame scrolling navigation mode. In either case, step 518 determines the user's wish by accepting either a “select” command to enter hyperlink navigation mode as in step 512, or by accepting another navigation command to continue screen navigation as in step 508.

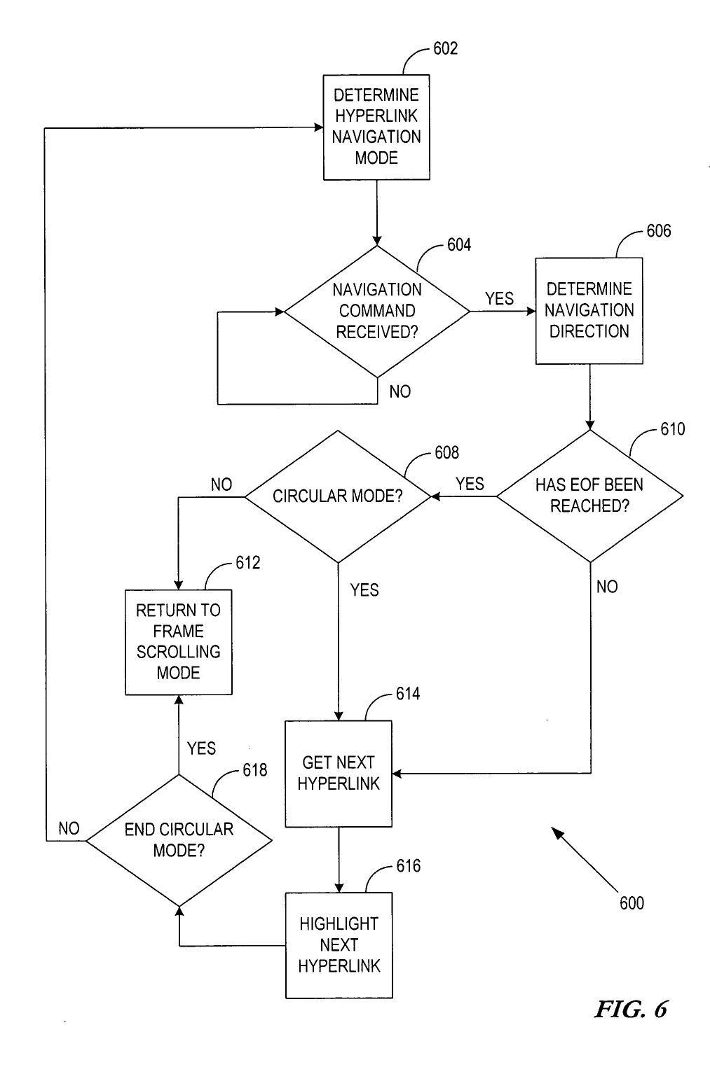

Flow diagram 600 of FIG. 6 illustrates an exemplary operation of hyperlink navigation mode according to the present invention, which is entered at step 512 of FIG. 5. The hyperlink navigation mode, e.g., circular or non-circular navigation mode, is determined in step 602 according to configuration settings of, for example, mobile terminal 102. Once a navigation command is received in step 604, its direction is determined in step 606. If the direction is reverse, then the previous hyperlink is retrieved from the markup file. If, on the other hand, the direction is forward, then the next hyperlink is retrieved from the markup file. If an End of File (EOF) has been detected by the browser, either by reaching the first or the last hyperlink definition in the markup file as in step 610, then the navigation mode is checked in step 608. If circular navigation mode is active, then the next hyperlink in the markup file is retrieved by the browser as in step 614. Otherwise, if circular mode is not active, then hyperlink navigation mode is automatically terminated and a return to frame scrolling mode is executed by step 612.

Any hyperlink retrieved and subsequently made active is highlighted in step 616 and step 618 determines whether the user wishes to manually terminate circular hyperlink navigation mode. If the user wishes to end circular hyperlink navigation mode, then a return to frame scrolling mode is executed in step 612. Otherwise, any hyperlink navigation mode change made by the user may be detected in step 602 and other navigation commands detected as in step 604.

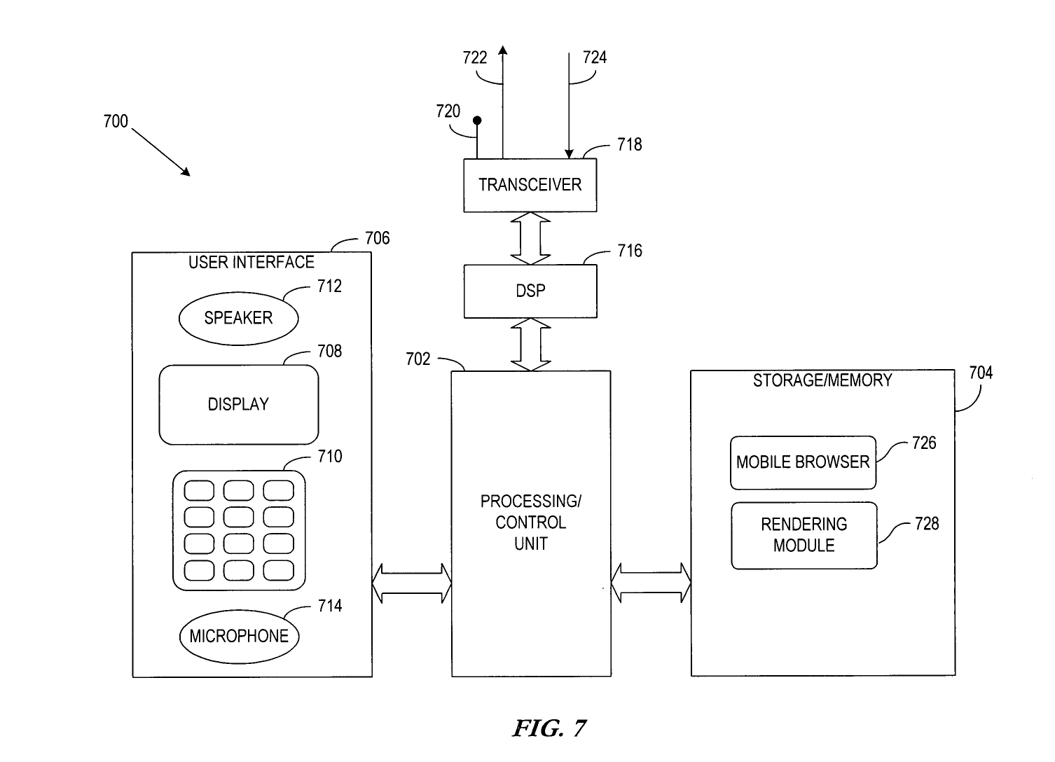

The invention is a modular invention, whereby processing functions within a mobile terminal may be utilized to implement the present invention. The mobile devices may be any type of wireless device, such as wireless/cellular telephones, personal digital assistants (PDAs), or other wireless handsets, as well as portable computing devices capable of wireless communication. These mobile devices utilize computing circuitry and software to control and manage the conventional device activity as well as the functionality provided by the present invention. Hardware, firmware, software or a combination thereof may be used to perform the various browsing functions described herein. An example of a representative mobile terminal computing system capable of carrying out operations in accordance with the invention is illustrated in FIG. 7. Those skilled in the art will appreciate that the exemplary mobile computing environment 700 is merely representative of general functions that may be associated with such mobile devices, and also that landline computing systems similarly include computing circuitry to perform such operations.

The exemplary mobile computing arrangement 700 suitable for facilitating browsing functions in accordance with the present invention may be associated with a number of different types of wireless devices. The representative mobile computing arrangement 700 includes a processing/control unit 702, such as a microprocessor, reduced instruction set computer (RISC), or other central processing module. The processing unit 702 need not be a single device, and may include one or more processors. For example, the processing unit may include a master processor and associated slave processors coupled to communicate with the master processor.

The processing unit 702 controls the basic functions of the mobile terminal, and also those functions associated with the present invention as dictated by mobile browser 726 and rendering module 728 available in the program storage/memory 704. Thus, the processing unit 702 is capable of accessing markup content using mobile browser 726 and navigating the content either in frame scrolling or hyperlink navigation modes as determined by rendering module 728. The program storage/memory 704 may also include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc.

In one embodiment of the invention, the program modules associated with the storage/memory 704 are stored in non-volatile electrically-erasable, programmable ROM (EEPROM), flash ROM, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The processor 702 is also coupled to user-interface 706 elements associated with the mobile terminal. The user-interface 706 of the mobile terminal may include, for example, a display 708 such as a liquid crystal display, a keypad 710, speaker 712, and microphone 714. These and other user-interface components are coupled to the processor 702 as is known in the art. Other user-interface mechanisms may be employed, such as voice commands or acceleration/tilt commands, to implement browsing functions according to the present invention.

The mobile computing arrangement 700 also includes conventional circuitry for performing wireless transmissions. A digital signal processor (DSP) 716 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 718, generally coupled to an antenna 720, transmits the outgoing radio signals 722 and receives the incoming radio signals 724 associated with the wireless device.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art will be readily able to combine software created as described with appropriate general purpose or special purpose computer hardware to create a browsing system, apparatus, and method in accordance with the present invention.

The foregoing description of the various embodiments of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A network browsing system, comprising:
a network having Web pages addressable by a Uniform Resource Locator (URL); and
a mobile browser coupled to access the Web pages and coupled to receive markup definitions associated with the Web pages, the mobile browser generating a content window from a portion of the Web page, wherein navigation to the content window and within the content window is facilitated without the use of a pointing device.

2. The network browsing system according to claim 1, wherein locations of the portions of the Web page are predetermined.

3. The network browsing system according to claim 2, wherein selection of an adjacent location of a portion from a current location of a portion occurs in response to navigational input.

4. The network browsing system according to claim 3, wherein the navigational input includes at least one of keypad, verbal, and tilt command.

5. The network browsing system according to claim 4, wherein the keypad commands are implemented with at least two keys.

6. The network browsing system according to claim 1, wherein locations of the portions of the Web page are determined by a scrolling window, wherein a position of the scrolling window is determined from navigational input.

7. The network browsing system according to claim 6, wherein the navigational input includes at least one of keypad, verbal, and tilt command.

8. The network browsing system according to claim 1, wherein navigation within the content window is conducted in response to selection of the content window for hyperlink navigation.

9. The network browsing system according to claim 8, wherein navigation within the content window comprises:
parsing markup language that defines the content window;
identifying keywords within the parsed markup language; and
highlighting a portion of the content window corresponding to a selected keyword.

10. The network browsing system according to claim 9, wherein navigational input causes selection of an identified keyword that is adjacent to the selected keyword.

11. The network browsing system according to claim 10, wherein selection of identified keywords occurs in circular fashion within a set of identified keywords.

12. The network browsing system according to claim 11, wherein navigation within the content window terminates in response to manual input.

13. The network browsing system according to claim 9, wherein navigation within the content window terminates in response to navigating outside of a set of identified keywords.

14. A mobile terminal wirelessly coupled to a network having Web pages accessible by a Uniform Resource Locator (URL), the mobile terminal comprising:
a memory capable of storing at least one of a mobile browser and a rendering module;
a transceiver configured by the mobile browser to facilitate markup language exchange with a plurality of Web pages; and
a processor coupled to the memory and configured to render a browser window corresponding to a portion of an exchanged Web page and facilitating navigation within the browser window without the use of a pointing device.

15. The mobile terminal according to claim 14, wherein a plurality of portions combine to form the exchanged Web page.

16. The mobile terminal according to claim 15, wherein locations of the plurality of portions are predetermined.

17. The mobile terminal according to claim 14, wherein a location of the portion is determined by placement of a scrolling window.

18. The mobile terminal according to claim 14, wherein the mobile terminal facilitates navigational input to select a location of the portion of the Web page to be displayed by the browser window.

19. The mobile terminal according to claim 18, wherein the mobile terminal facilitates navigational input to select a location within the browser window.

20. The mobile terminal according to claim 19, wherein the navigational input comprises at least one of keypad, verbal, and tilt command.

21. A computer-readable medium having instructions stored thereon which are executable by a mobile terminal for rendering browser windows by performing steps comprising:
receiving documents containing hyperlinks;
defining a browser window to display selected portions of the document; and
freezing the browser window to allow navigation within the browser window, wherein selection of the portions of the document and navigation within the selected portions is facilitated without the use of a pointing device.

22. A method for rendering browser windows on a mobile terminal, comprising:
receiving markup definitions;
defining at least one portion of the markup definitions to be displayed by a browser window; and
navigating between the at least one portion without the use of a pointing device.

23. The method according to claim 22, wherein the at least one portion is one of a predetermined set of portions.

24. The method according to claim 23, wherein navigation within the predetermined set of portions occurs by sequentially selecting adjacent portions.

25. The method according to claim 22, wherein the at least one portion is defined by a scrolling window.

26. The method according to claim 25, wherein navigation occurs by incrementally changing the position of the scrolling window.

27. A method for navigating within a browser window generated by a mobile browser, comprising:
locating keywords contained within a document displayed by the browser window;
highlighting a portion of the browser window corresponding to a selected keyword; and
selecting the keywords without the use of a pointing device.

28. The method according to claim 27, wherein locating the keywords comprises parsing the document for hyperlinks.

29. The method according to claim 28, wherein selecting other keywords comprises navigating between each hyperlink parsed.
